(19) United States
(12) Patent Application Publication
(10) Pub. No.: US 2005/0078036 A1
(43) Pub. Date: Apr. 14, 2005

(54) Projectile comprising a reception antenna for a satellite navigation receiver

(76) Inventor: Volker Koch, Ruckersdorf (DE)

Correspondence Address: Leopold Presser;Scully Scott Murphy & Presser, 400 Garden City Plaza, Garden City, NY, 11530, US

(21) Appl. No.: 10/491,594

(22) PCT Filed: Oct. 4, 2001
(86) PCT No.: PCT/EP01/11463

(51) Int. Cl. H01Q 1/24

(52) U.S. Cl. 343/702

(57) ABSTRACT

A projectile (12) carries, inside its interchangeable cone (11) and under the cone's ballistic radome shroud (14), a combined antenna (21) whose tuning corresponds to both the basic frequency of the radar (17) of a distance detonator as well as to the third harmonic wave of the carrier frequency of a satellite navigation receiver (20) whereby enabling both systems to be operated via this one combined antenna (21). For decoupling, it is provided that the distance radar (18) is firstly operated when the navigation receiver (20) is switched off once the projectile (12) has arrived above the target area while traveling along its corrected trajectory.

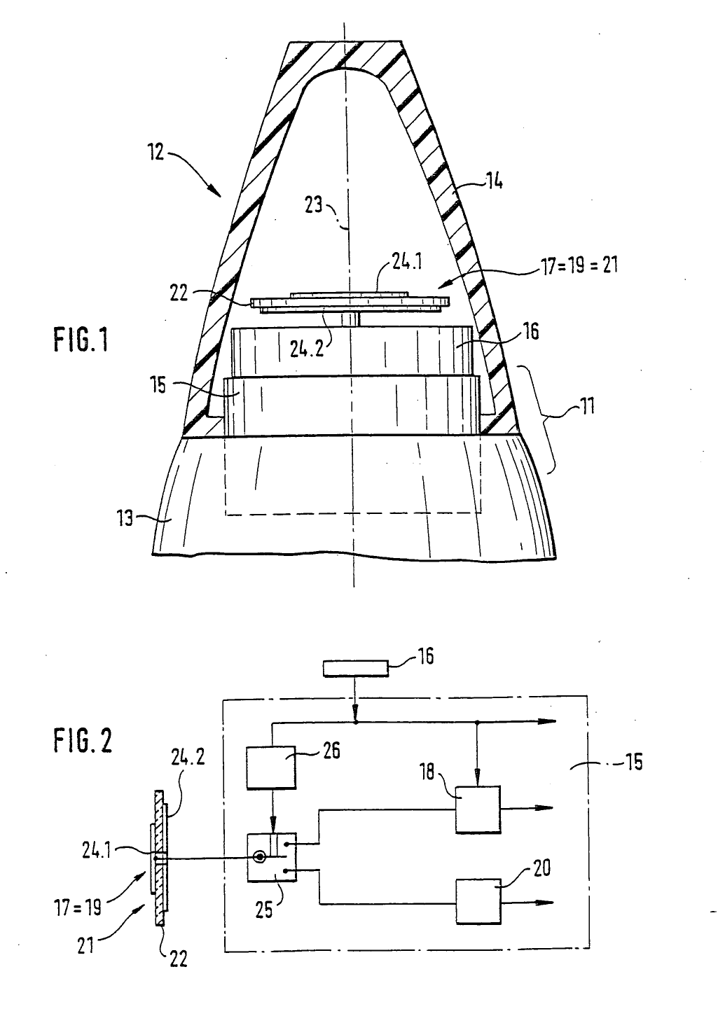

The present invention relates to an artillery projectile fuse equipped according to the preamble of claim 1, as is known from U.S. Pat. No. 6,098,547 A, for example.

Therein, a receiving circuit in the base of the fuse, which is shaped like a truncated cone, is connected along its axis via a coaxial cable to a dielectric disk antenna, which is installed in the fuse concentrically and transversely to the lengthwise axis in front of the receiving circuit in the flight direction. The disk antenna is in turn a circumferential slot antenna, transverse to the axis, for navigation and telemetry frequencies, having inductive tuning of bandwidths and mid-band frequencies via electrically conductive channels, whose axes are parallel, between the electrically conductive laminations of the dielectric disk on both sides. The transverse emission of its antenna characteristic is also encouraged in that the dielectric disk extends out into the outer lateral surface of the fuse hood and only the front covering of the disk maintains a small radial spacing from the hood. Such an antenna orientation transverse to the flight direction is expedient for radio links to the hemisphere; however, it is not suitable for a range measurement to the front in the flight direction, as would be necessary for fuse triggering upon reaching a predetermined remaining range to an object or above ground. Using such a single-layered disk antenna, resonance frequencies which deviate strongly from one another also cannot be generated, because of which the telemetry frequencies are to be selected in the same order of magnitude due to the externally predetermined carrier frequencies of the navigation satellites. This complicates undisturbed transmission and analysis of this information, which varies greatly per se, whose transmission and processing in significantly different frequency bands would be preferable.

A similar multifrequency antenna is known from U.S. Pat. No. 4,305,078 A, with the characteristic therein that multiple inductively tunable disk antennas of this type are positioned one on top of another like a sandwich and electrically connected in series as a transversely-emitting slot antenna.

A missile having a multisensor target control, which has a combination of an infrared detector and radar detector, is known from U.S. Pat. No. 6,150,974 A. For a disk antenna that which emits frontally because of its only localized covering, a dielectric material transparent to infrared radiation is selected so that in the region of the missile tip, the infrared detector may be positioned behind the disk antenna, which is installed coaxially and transversely to the lengthwise axis, in the flight direction.

According to DE 24 08 578 A1, a dielectric disk antenna usable both for telemetry tasks and as a ranged fuse, having the same frequency range for both tasks, has a square electrode covering on each side of the disk, the smaller of which has an edge length approximately equal to half of the average operating wavelength of the antenna. Since tuning for the two different tasks is performed via asymmetrical recesses in the smaller electrode surface, an omnidirectionally uniform antenna characteristic does not result, through which reception of amplitude-modulated information in the rotating projectile is decisively interfered with.

U.S. Pat. No. 6,943,520 A describes a dielectric disk antenna, which is capacitively tunable in the peak range of the power supply, in the form of a triangular dielectric disk which is fitted in the fuse tip along the fuse lengthwise axis.

For the artillery rocket according to EP 0 840 393 8, a dielectric carrier substrate is provided on the outer lateral surface of its fuselage for electrically conductive areas which are coupled to one another thereon and which are laid out as the antenna structure for the carrier frequency of navigation satellites. As much as these lateral surface antenna as have already proven themselves for receiving satellite location information, they nonetheless have the disadvantage of not being able to be applied to the projectile—particularly as retrofitting—without problems in regard to the mechanical strain when being fired from a barrel.

The present invention is based on the technical object of refining a fuse equipped according to the species in such a way that, because of a small-scale multifrequency antenna for greatly varying frequency ranges such as satellite navigation and proximity fuse triggering, it is usable in the tight space of the fuse tip in addition to the installed fuse equipment in manifold ways and nonetheless with functional reliability.

This object is achieved according to the present invention as described by the feature combination of the main claim essentially in that a dielectric antenna which is positioned inside the fuse ogive and laid out in front for frontal emission is operated using a radar range finder frequency which is in the magnitude of the third harmonic of an available satellite carrier frequency, with this antenna optionally usable initially for navigation tasks and, towards the end of the mission, only then for the proximity measurement for fuse triggering instead.

1. An artillery projectile fuse having a hood (14), a dielectric antenna (17) installed in said hood (14) extending transversely to a rotational longitudinal axis (23) of said fuse, said antenna being in the form of a dielectric carrier disk (22) which is electrically conductive and laminated in geometrically different areas on both sides of said disk,
characterized in that, with the laminated areas (24) of the antenna (21) being laid out point-symmetrical relative to the longitudinal axis (23) for the frequency of a radar range finder at the third harmonic of a navigation satellite carrier frequency, the carrier disk (22) is positioned under the fuse hood (14) with the area (24.2) of a rear disk lamination of said areas (24) projecting in all directions beyond the confines of the front area (24.1), so as to produce an antenna (21) combined from a navigation antenna (19) and a radar antenna (17), having a hemispherical sight oriented forward in the flight direction of said fuse.

2. The fuse according to claim 1,
characterized in that its combination antenna (21) is switchable alternately to a navigation receiver (20) or to a radar range finder (18) via a changeover switch (25).

3. The fuse according to claim 2,
characterized in that said combination antenna (21) is initially operable for a satellite navigation receiver (20) for path measurement for effectuating a path correction and subsequently operable for the radar range finder for effectuating a proximity triggering above ground.

4. The fuse according to claim 2,
characterized in that a control stage (26), which is programmable to different times of use of the radar operation via a coil (16), is connected downstream of the changeover switch (25).

5. The fuse according to claim 4,
characterized in that said fuse is equipped behind the carrier disk (21) in the flight direction with a programming coil (16) for behavioral control thereof.
